(19) United States
(12) Patent Application Publication
(10) Pub. No.: US 2022/0105759 A1
(43) Pub. Date: Apr. 7, 2022

(54) DEVICE INTRODUCED AT THE BASE FOR FIXING THE KINGPIN IN A SEMI-TRAILER

(71) Applicant: Moacir Faust Correa, Curitiba (BR)

(72) Inventor: Moacir Faust Correa, Curitiba (BR)

(21) Appl. No.: 17/111,666

(22) Filed: Dec. 4, 2020

(30) Foreign Application Priority Data
Oct. 5, 2020 (BR) BR 20 20200204403

(51) Int. Cl. B60D 1/01; B62D 53/08

(52) U.S. Cl. CPC B60D 1/015; B62D 53/0842

(57) ABSTRACT

Base for fixing the kingpin on a semi-trailer, belonging to the group of vehicle towing devices, including devices for fifth-wheel couplings, to hook the semi-trailer to the tractor vehicle. Base consists of a monobloc structure featuring quadrangular geometry with a circular orifice at its center of gravity, its upper face featuring a tubular cylindrical projection coaxially perpendicular to the circular orifice. Side faces are fully opened. Frontal and back faces feature a U-shaped opening in their upper halves. Base for fixing the kingpin is fixed to the upper face of the horizontal platform of the semi-trailer chassis. It receives a circular hole, coaxial to a second circular hole present at such base. Kingpin is inserted at the base through its upper portion, so that it crosses both it and the horizontal platform, protruding perpendicularly from its lower face downwards, to be coupled to the fifth wheel of the tractor vehicle.

### USE SCOPE

The purpose of this utility model patent is a practical and innovative base model for fixing a kingpin on a semi-trailer, belonging to the field of vehicle towing devices, including devices for fifth wheel connections, more precisely in order to connect the semi-trailer to the tractor vehicle, which originally received a constructive disposition, aiming at improving its use and performance in relation to other models usually found on the market.

It is an innovative device for fixing the king pin on the semi-trailer chassis, which, unlike the usual models, presents substantial practicality and simplicity when changing its positioning along the chassis of the semi-trailer, combined with robust durability and low cost.

Therefore, within the patent application in question, there is a device specially designed and developed to obtain enormous practicality and which features great advantages, both in its use and in its manufacture.

Moreover, it is also an objective of this application, to present a base model for fixing of the kingpin on a semi-trailer featuring low costs for its industrial feasibility, whereas meeting the requirements of robustness, safety and utilitarian practicality, thus offering to the consumer public, an additional option in the parts market, which, unlike similar models, offers several possibilities and benefits to its users, becoming a model of great acceptance in the consumer market.

### STATE OF THE ART

The semi-trailer is the term commonly used in the road hauling market to designate the equipment that hauls cargo by road, which is pulled by a hauling truck tractor.

This semi-trailer is coupled to the truck through the hitch, composed of the fifth wheel on the truck and the kingpin on the semi-trailer. Semi-trailers usually feature one to three axles without a self-propelling force.

As known, notably by technicians on the subject, usually kingpins have flanges which are attached to the chassis of semi-trailers with screws.

In this sense, and also to further detail the state of the art, some patent documents that deal with devices for the same purpose can be quoted, whereas not achieving the inventive merit and the differences now revealed, as follows.

The patent document MU 78019419 U2, entitled “MOVABLE KINGPIN COUPLING DEVICE”, reveals a device that allows the standardization of the tractor position of cargo hauling trailers, through a device known as kingpin, characterized by having constructive and functional technical provisions, which allows the correct distribution of the load on several types of tractor trucks. It has a manual lever directly connected to the locking pin, attached to a bar that acts as a guide for the perforated bar.

The patent document PI 0503411-6 A2, entitled “FIFTH-WHEEL COUPLING AND KINGPIN”, reveals an inverted assembly regarding the coupling status, featuring the guide opening facing forward, and the contact surface facing down, installed on the trailer or dolly, not on the front driving vehicle. Usually, the fifth wheel is mounted on the towed unit and the kingpin on the driving unit, both in inverted positions.

The patent document PI 0803402-8 A2, entitled “DEVICE WITH KINGPIN OVER ROTATING DISC FOR HITCHING ON FIFTH WHEEL OF TRUCK AND SIMILAR VEHICLES”, reveals a fixed upper disk mounted on a lower rotating disk, where the kingpin, which contains a fixing flange, is mounted and which contains the ball row to support axial loads and the ball row to support radial loads inside it. The kingpin is fixed to the lower rotating disk, using screws. The assembly of the ball row is made through the hole, which is closed by the locking pin. The device also has a lubrication system composed of a lubricating pin, screwed into the lubricating channel that forks into the two rows of metallic balls.

Patent document BR 10 2012 028602 5 A2, entitled “IMPROVEMENTS INTRODUCED IN KINGPIN CONFIGURING A DYNAMOMETRIC SENSOR”, reveals a device comprised of a main body assembled from a flange with several holes for fixation, its central section projecting a cylindrical segment that has its diameter abruptly reduced, forming a coupling channel that holds a locking ring on its upside, configuring a coupling kingpin, characterized by the cylindrical segment being provided with blind cross holes arranged at 180°, forming recess conditioners that receive sensors, where the load cell/dynamometer is formed, from the supply voltage (ei) that is parallel with the resistor (Rirs), from a parallel terminal (ei and Rirs) connected to a resistor (Rss) that has its other end connected to a resistor inside the dynanometric coupling kingpin (Rmc), that has two connections at its other terminal: one to the strain gauge, and other to the strain gauge. which is connected to another resistor inside the dynanometric coupling kingpin (Rgc); from the other terminal of this resistor (Rgc), there are two connections: one is connected to an output terminal (eo), and the second one connects to another strain gauge; the other terminal of this strain gauge has two other connections: one to the resistor inside the dynanometric coupling kingpin (Rmc)—the other terminal of this resistor (Rmc) connects to the other terminal of the parallel (ei and Rirs)—and the second connection of the terminal of the strain gauge is connected to another resistor (Rbal), which has connected to its other terminal a strain gauge; the other terminal of this strain gauge has two connections: the first one is connected to the other output terminal (eo) and the second one is connected to the other terminal of the strain gauge; the power and signal output are inserted into oblique holes on the edges of the bottom of the holes. Such oblique holes converge to the central section of the flange, configuring an elliptical hole, and a sealing resin is applied over the sensors while the blind cross holes receive plugs forming a dynanometric coupling kingpin.

Patent document BR 20 2013 017220 6 Y1, entitled “PINKING WITH A MAGNETIC DEVICE”, reveals a kingpin containing a magnetic device, which can be a magnet or an electromagnet. As it is a point of rotation between the towing vehicle and the towed vehicle, this assembly, when rotated, will change the position of the magnetic device. Consequently, the magnetic field in the region will change. This change will be sensed by a magnetic field change sensor, which can feed an electronic vehicle control system.

The patent document BR 10 2014 031759 7 A2, entitled “KINGPIN, AUTOMATIC DISARM DEVICE OF SUCH PIN AND ITS OPERATING PROCESS”, reveals a device that, through the proper combination of sensors and valves, promotes the automatic disarm of the kingpin with the vehicle in motion, thanks to a propulsion mechanism. In the imminence of a lateral tipping, felt by the sensors and/or by the activation of the panic pedal, the locking pins, which keep such kingpin attached to the coupling cup inside the fixed flange, are retracted, releasing the semi-trailer of its tractor truck.

Patent document BR 20 2015 004320 7 U2, entitled “MAGNETIC PINKING ASSEMBLY”, reveals a king pin for pinking/fifth-wheel couplings which is magnetized or features an attached magnet. This item has great relevance for embedded systems of vehicles having magnetic sensors on the fifth wheel.

### DEFICIENT POINTS OF THE STATE OF THE ART

The major drawback of the conventional kingpin model lies specifically in the difficulty caused when changing its position. In this process, it is quite common for the screws to break, due oxidation and dirt affecting them. Another drawback is thread striping during screw tightening procedures.

The change in the positioning of the kingpin is necessary for the correct distribution of the load on the different types of existing tractor vehicles. It is a recurring process.

### PROPOSED SOLUTION

Having these drawbacks in mind, after several researches and studies, the inventor, a person related to this field, created and developed the object of this patent, idealizing a base for fixing a kingpin in a semi-trailer, in which not only the mechanical and functional aspects were considered in the design of its manufacture, but also the shape, layout, and location of its parts and components, which, correctly positioned, increased its efficiency without causing any burden.

Thus, the patent herein was designed to create a device with the least number of parts possible, conveniently configured and arranged to allow the base for fixing the kingpin in semi-trailer to perform its functions with unmatched efficiency and versatility, without the aforementioned drawbacks.

This patent application presents a practical and innovative model of the base for fixing a kingpin on a semi-trailer, with all the aesthetic and functional qualities, designed and developed according to the most up-to-date techniques, thus enabling its broader use, within the several models of semi-trailers found on the market.

Its innovative format allows an excellent level of functionality to be obtained, offering a base model for fixing a kingpin on a semi-trailer, which has great durability, created mainly to simplify and speed up the change of the kingpin position; in addition to presenting greater mechanical resistance against impacts, it is more cost effective.

The configuration of the device, object of the patent herein, in its new constructive form, comprises a quadrangular base, equipped with a hole in its center of gravity and a tubular cylindrical projection on its upper side. Such quadrangular base strongly fixed to the upper side of the horizontal platform, which integrates the chassis of the semi-trailer, and the kingpin is inserted in its circular hole from top to bottom, so that it also crosses a shaped hole in the horizontal platform of the semi-trailer and protrudes perpendicularly from its bottom face downwards, ready to be coupled to the fifth wheel of the tractor vehicle.

Unlike the conventional model, where the kingpin is attached by means of screws in a circular base assembled on the bottom side of the horizontal platform of the chassis of the semi-trailer, within the object of the patent application herein, the kingpin is coupled by simple fitting in the quadrangular base, in presentation, positioned on the upper side of the horizontal platform of the semi-trailer.

It should be understood that the such device is extremely simple in its assembly; therefore, it is easily feasible while featuring excellent practical and functional results, offering an innovative assembly over the usual models.

Idealized with an innovative design, it results in a harmonic set, quite peculiar and, above all, characteristic. Besides the constructive aspect, the model stands out for its versatility and convenience of use.

### BRIEF DESCRIPTION OF THE DEVICE DRAWINGS

To complement the description herein, in order to obtain a better understanding of the features of this utility model, and in accordance with its preferred practical realization, attached to the description is a set of drawings, where, in an exemplified manner, although not a limiting one, the following has been represented:

FIG. 1—It shows a side view of the base for fixing the kingpin on a semi-trailer, featuring the kingpin.

FIG. 2—It shows a frontal view of the base for fixing the kingpin on a semi-trailer, featuring the kingpin.

FIG. 3—It shows a perspective upper view of the base for fixing the kingpin on a semi-trailer, featuring the kingpin.

FIG. 4—It shows a perspective bottom view of the base for fixing the kingpin on a semi-trailer, featuring the kingpin.

FIG. 5—It shows a perspective bottom view of the base for fixing the kingpin on a semi-trailer, without the kingpin.

FIG. 6—It shows a perspective upper view of the base for fixing the kingpin on a semi-trailer, featuring the kingpin to be inserted.

FIG. 7—It shows a frontal view of the base for fixing the kingpin on a semi-trailer, featuring the kingpin to be inserted.

FIG. 8—It shows a frontal view of the base for fixing the kingpin on a semi-trailer, featuring the kingpin partially inserted.

FIG. 9—It shows a perspective upper view of the base for fixing the kingpin on a semi-trailer, as it is being coupled over the upper side of the horizontal platform of the semi-trailer.

FIG. 10—It shows a view of a semi-trailer equipped with the base for fixing a kingpin.

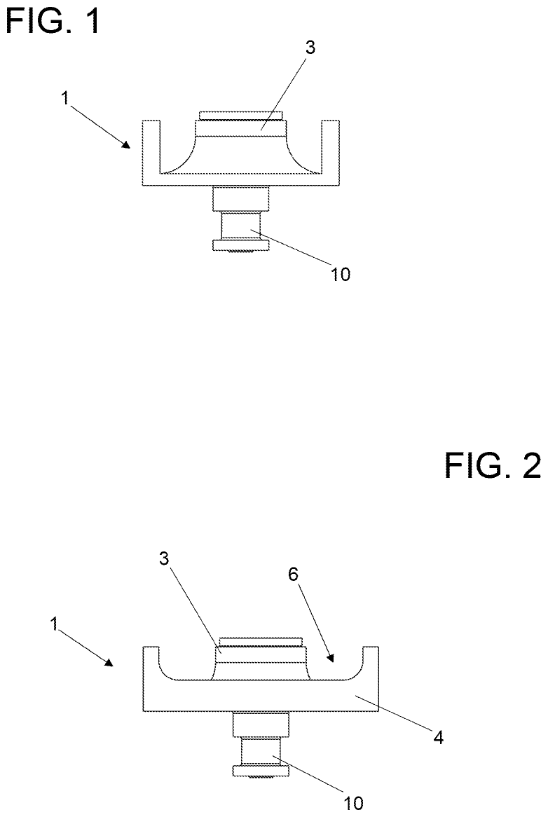

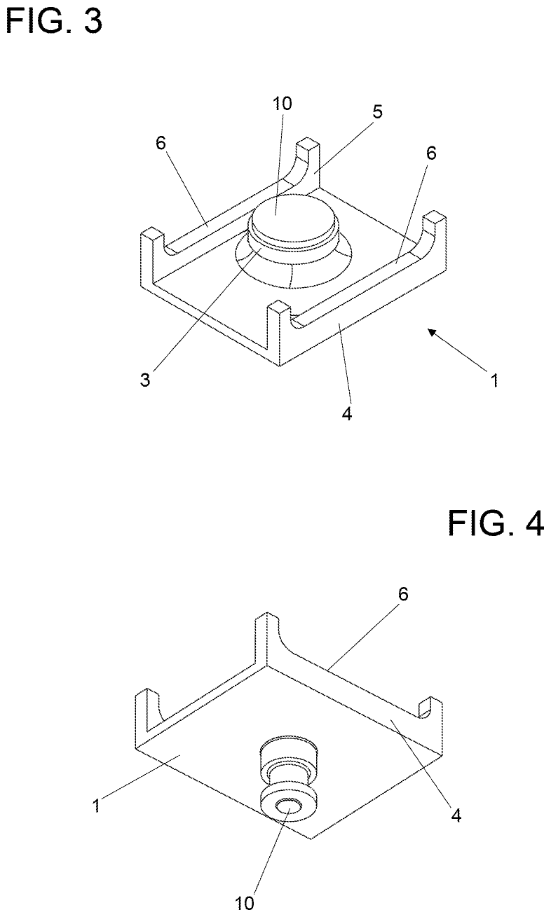

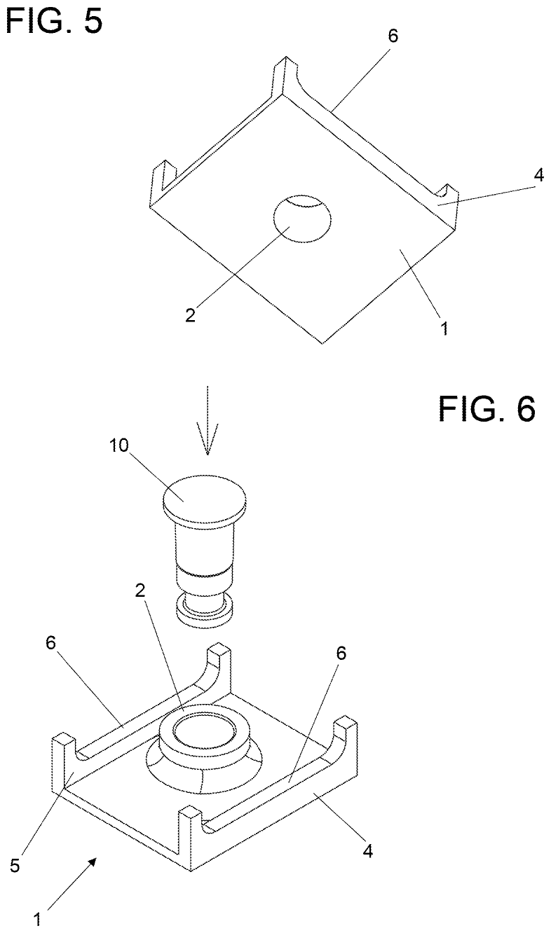

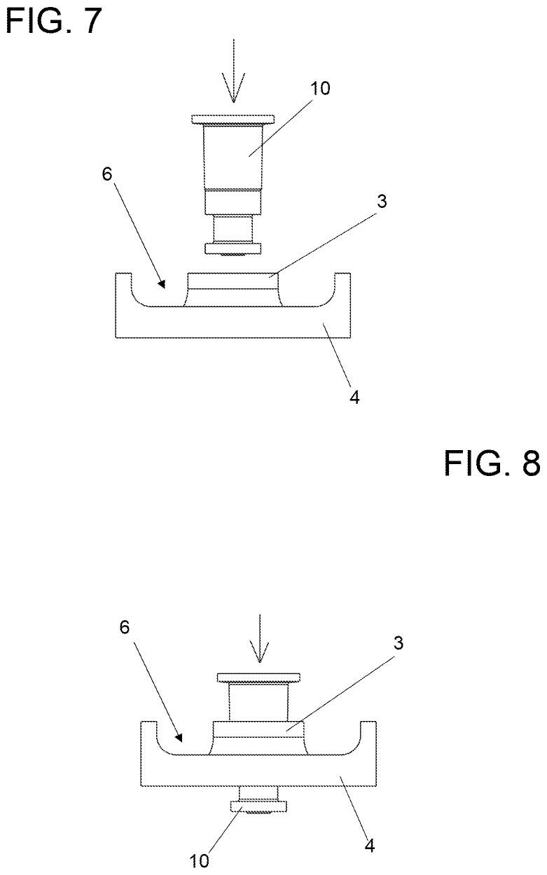

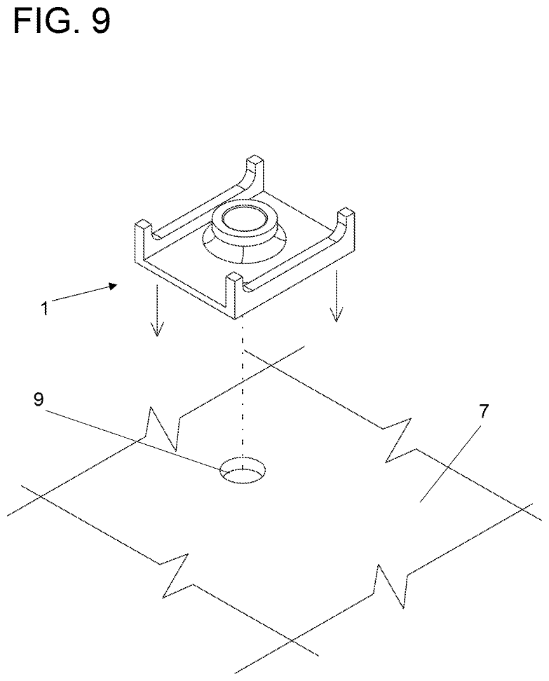

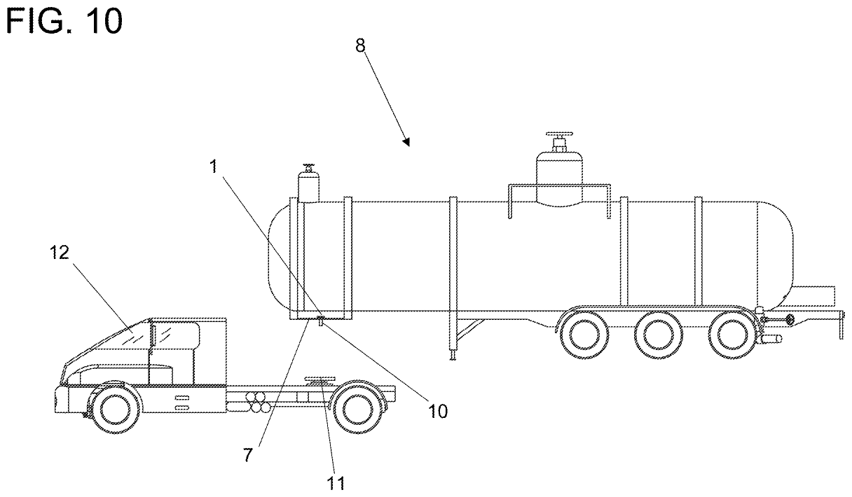

### DETAILED DESCRIPTION OF THE DEVICE

According to the aforementioned figures, the “DEVICE INTRODUCED AT THE BASE FOR FIXING THE KINGPIN IN A SEMI-TRAILER”, object of the patent herein, comprises a fixing base to which the kingpin is attached, which is coupled to the fifth wheel present in the tractor vehicle.

More specifically, the base for fixing the kingpin on a semi-trailer (1) consists of a monobloc structure that predominantly has a quadrangular geometry with a circular hole (2) within its center of gravity, with the upper side having a tubular cylindrical projection (3), which is coaxially perpendicular to the circular hole (2).

The side faces are fully opened and the front one (4) and the rear one (5) are partially opened, i.e., they have U-shaped openings (6) in their upper halves.

This base for fixing the kingpin on a semi-trailer (1) is strongly fixed to the upper side of the horizontal platform (7) of the semi-trailer chassis (8), by welding. It should be highlighted that it receives a circular hole (9), coaxial to the circular hole (2) present in such base (1) and the kingpin (10) is inserted in the base (1) by its upper portion, so that it crosses it and the horizontal platform (7), and protrude perpendicularly from its lower side downwards, in order to be coupled to the fifth wheel (11) of the tractor vehicle (12).

The fixation of the base (1) to the horizontal platform (7) of the semi-trailer (8) is reinforced by beams welded on the front and rear sides. Moreover, these beams are also welded to the horizontal platform (7).

The king pin (10) to be applied to this base (1) comprises a cylindrical element with a flange at its rear end and its front end has a standardized shape to fit the fifth wheel, i.e., a smaller flange dimension preceded by a cylindrical section of reduced diameter.

The process of removing the kingpin (10), compared to the process of removing the model within the state of the art is quite simplified and practical; it is enough to just apply a force from the bottom to the top.

It is noted that the removal of the kingpin for maintenance, replacement or for changing its position on semi-trailers is quite recurrent, so the simplification of this process is of substantial relevance for the road cargo hauling market.

It is certain that when the present utility model is put into practice, modifications might be made with regard to certain construction details and shape, without it implying departing from the fundamental principles that are clearly corroborated in the claim framework, thus becoming clear that the terminology used was for the purpose of description and not limitation.

1- “DEVICE INTRODUCED AT THE BASE FOR FIXING THE KINGPIN IN A SEMI-TRAILER”, characterized by the fact that it consists of a metallic and monobloc structure that predominantly has a quadrangular geometry with a circular hole (2) in its center of gravity, and the upper side has a tubular cylindrical projection (3) perpendicular to the circular hole (2), since the side faces are fully opened and the front one (4) and the rear one (5) features an U-shaped opening (6) in their upper halves; due to the fact that the base for fixing the kingpin on a semi-trailer (1) is strongly fixed to the upper side of the horizontal platform (7) of the chassis of the semi-trailer (8) by welding. It should be highlighted that it receives a circular hole (9), coaxial to the circular hole (2) present in such base (1) and the kingpin (10) is inserted in it (1) by its upper portion, so that it crosses it and the horizontal platform (7) and protrudes perpendicularly from its lower face downwards, and the fixation of the base (1) to the horizontal platform of the semi-trailer is reinforced by beams welded on the front (4) and rear (5) sides; sometimes, theses beams are welded on the horizontal platform.
